(19) United States
(12) Patent Application Publication
(10) Pub. No.: US 2026/0180409 A1
(43) Pub. Date: Jun. 25, 2026

(54) MOTOR, BRUSHLESS EXCITER SYSTEM AND A MOBILITY DEVICE INCLUDING THE SAME

(71) Applicants: HYUNDAI MOTOR COMPANY, Seoul (KR); KIA CORPORATION, Seoul (KR); CHALMERS UNIVERSITY OF TECHNOLOGY, Gothenburg (SE)

(72) Inventors: Hyung Kwan Jang, Hwaseong-si (KR); Byung Ho Min, Hwaseong-si (KR); Yujing Liu, Gothenburg (SE)

(73) Assignees: HYUNDAI MOTOR COMPANY, Seoul (KR); KIA CORPORATION, Seoul (KR); CHALMERS UNIVERSITY OF TECHNOLOGY, Gothenburg (SE)

(21) Appl. No.: 19/227,785

(22) Filed: Jun. 4, 2025

(30) Foreign Application Priority Data
Dec. 20, 2024 (KR) 10-2024-0192970

(51) Int. Cl. H02K 11/042; H02K 1/16; H02K 1/26; H02K 5/22; H02K 7/08; H02K 11/33; H02K 55/00

(52) U.S. Cl. CPC H02K 11/042; H02K 1/16; H02K 1/26; H02K 5/225; H02K 7/08; H02K 11/33; H02K 55/00

(57) ABSTRACT

A motor includes: a stator outputting magnetic flux; a rotor outputting magnetic flux to be rotated by the magnetic flux of the stator; a secondary coil rotatable by the rotation of the rotor; a rectifier configured to rectify a current of the secondary coil and output the rectified current to the rotor; and a primary coil magnetically couplable to the secondary coil.

### CROSS-REFERENCE TO RELATED APPLICATIONS

This application claims benefit of and priority to Korean Patent Application No. 10-2024-0192970 filed on Dec. 20, 2024 in the Korean Intellectual Property Office, the disclosure of which is incorporated herein by reference in its entirety.

### FIELD

The present disclosure relates to a motor, a brushless exciter system, and a mobility device.

### BACKGROUND

In general, a motor (an electric motor) may be classified as a direct current (DC) motor or an alternating current (AC) motor, depending on a power source used therefor. Such an AC motor may be classified as a synchronous motor and an induction motor, depending on structures thereof. A synchronous motor has high efficiency and is easy to control, but is difficult to manufacture and relatively high in price. An induction motor has been widely used because it has a simple structure, is resistant to external shocks, and is inexpensive.

Recently, as research and development of electric vehicles have accelerated, demand for an electric motor has also increased significantly. The electric motor used as a driving source for an electric vehicle is usually a high-speed and high-power motor.

A mobility device (i.e., mobility apparatus or vehicle), including a hybrid electric vehicle, an aerial mobility device, or the like, may be partially or entirely driven by a motor, rather than by existing internal combustion engines. As a motor for such a mobility device, a wound field synchronous motor (WFSM) or a permanent magnet synchronous motor (PMSM) to which a permanent magnet is applied, or the like, may be used. Some types of motors may require a brush for excitation.

### SUMMARY

A brush for excitation, which may be used for a motor, may cause mechanical friction between a rotating conductive structure and a fixed conductive structure, cause a decrease in efficiency and/or a decrease in control characteristics due to the mechanical friction, or require a larger volume/weight (and/or periodic maintenance) of the motor because of the mechanical friction.

A motor, a brushless exciter system, and a mobility device according to an embodiment of the present disclosure may eliminate disadvantages of a brush (e.g., mechanical friction, reduced efficiency, reduced control characteristics, additional volume/weight requirements, and periodic maintenance requirements) while providing an excitation structure.

According to an aspect of the present disclosure, a motor may include a stator configured to output magnetic flux; a rotor configured to output magnetic flux to be rotated by the magnetic flux of the stator; a secondary coil disposed to be rotated by the rotation of the rotor; a rectifier configured to rectify a current of the secondary coil and output the rectified current to the rotor; and a primary coil disposed to be magnetically coupled to the secondary coil.

For example, the rotor may include a rotating shaft, the secondary coil may be disposed to surround the rotating shaft in a winding direction of the secondary coil, and the primary coil may be disposed to surround the rotating shaft in a winding direction of the primary coil.

For example, the rotor may further include a bearing surrounding the rotating shaft, and the primary coil may be disposed to surround at least a portion of the bearing in a winding direction of the primary coil.

For example, the primary coil may include a primary terminal wired to the outside of the motor to receive an alternating current from the outside of the motor.

For example, the stator may include: a stator body having an internal space in which the rotor is disposed; and a stator coil portion arranged in the stator body in a rotational direction of the rotor. The stator body may have an electrical connection path between the secondary coil and the rotor.

For example, the number of turns of the secondary coil may be less than the number of turns of the primary coil, and a line width of the secondary coil may be wider (or greater) than a line width of the primary coil.

For example, the rotor may include a rotor coil portion, and the rotor coil portion may include a superconducting coil.

For example, the rotor may include a rotor coil portion. The secondary coil may include an anode terminal, a cathode terminal, and a neutral terminal. The rectifier may include a rectifier anode portion electrically connected between one end of the rotor coil portion and the anode terminal, and a rectifier cathode portion electrically connected between one end of the rotor coil portion and the cathode terminal. The neutral terminal may be electrically connected to the other end of the rotor coil portion.

For example, the rectifier anode portion may include an anode portion diode, and the rectifier cathode portion may include a cathode portion diode.

For example, the neutral terminal may include an anode portion neutral terminal and a cathode portion neutral terminal. The secondary coil may include a secondary anode portion wound between the anode terminal and the anode portion neutral terminal, and a secondary cathode portion wound between the cathode terminal and the cathode portion neutral terminal.

For example, the secondary anode portion may include at least one secondary anode upper layer, at least one secondary anode lower layer, and a secondary anode lifting portion connected between the at least one secondary anode upper layer and the at least one secondary anode lower layer. The secondary cathode portion may include at least one secondary cathode upper layer, at least one secondary cathode lower layer, and a secondary cathode lifting portion connected between the at least one secondary cathode upper layer and the at least one secondary cathode lower layer. The at least one secondary anode upper layer and the at least one secondary cathode lower layer may overlap each other in a direction perpendicular to a winding direction. The at least one secondary cathode upper layer and the at least one secondary anode lower layer may overlap each other in a direction perpendicular to the winding direction.

For example, the at least one secondary anode upper layer may include a plurality of secondary anode upper layers. The at least one secondary anode lower layer may include a plurality of secondary anode lower layers. The at least one secondary cathode upper layer may include a plurality of secondary cathode upper layers. The at least one secondary cathode lower layer may include a plurality of secondary cathode lower layers. Respective secondary anode upper layers of the plurality of secondary anode upper layers and respective secondary cathode lower layers of the plurality of secondary cathode lower layers may be alternately stacked. Respective secondary cathode upper layers of the plurality of secondary cathode upper layers and respective secondary anode lower layers of the plurality of secondary anode lower layers may be alternately stacked.

For example, the motor may further include a tube-shaped magnetic core including a ferromagnetic material, and the primary coil and the secondary coil may be disposed within the magnetic core.

According to an aspect of the present disclosure, a brushless exciter system may include: a first inverter configured to convert a direct current (DC) into an alternating current (AC) and output a first alternating current (AC); a primary coil configured to receive the first alternating current (AC) from the first inverter; and a secondary coil magnetically coupled to the primary coil and electrically connected to a rotor of the motor.

For example, the brushless exciter system may further include a second inverter configured to convert a direct current (DC) into an alternating current (AC) and output a second alternating current (AC) to a stator of the motor. The first inverter may include a plurality of switching elements combined in an H-bridge structure.

For example, the brushless exciter system may further include a rectifier electrically connected between the secondary coil and the motor. The rectifier may be configured to rectify a current of the secondary coil through a single anode portion diode and a single cathode portion diode.

For example, the number of turns of the secondary coil may be less than the number of turns of the primary coil, a line width of the secondary coil may be wider (or greater) than a line width of the primary coil, and the motor may include a superconducting coil.

For example, the secondary coil may include an anode terminal, a cathode terminal, and a neutral terminal. The neutral terminal may include an anode portion neutral terminal and a cathode portion neutral terminal. The secondary coil may include a secondary anode portion wound between the anode terminal and the anode neural terminal, and a secondary cathode portion wound between the cathode terminal and the cathode portion neutral terminal. The secondary anode portion may include at least one secondary anode upper layer, at least one secondary anode lower layer, and a secondary anode lifting portion connected between the at least one secondary anode upper layer and the at least one secondary anode lower layer. The secondary cathode portion may include at least one secondary cathode upper layer, at least one secondary cathode lower layer, and a secondary cathode lifting portion connected between the at least one secondary cathode upper layer and the at least one secondary cathode lower layer. The at least one secondary anode upper layer and the at least one secondary cathode lower layer may overlap each other in a direction perpendicular to a winding direction. The at least one secondary cathode upper layer and the at least one secondary anode lower layer may overlap each other in a direction perpendicular to the winding direction.

For example, the motor may include a rotating shaft, the secondary coil may be disposed to surround the rotating shaft in a winding direction of the secondary coil, and the primary coil may be disposed to surround the rotating shaft in a winding direction of the primary coil.

According to an aspect of the present disclosure, a mobility device may include a body; at least one driving means (e.g., at least one of a wheel or a propeller) provided in the body; a battery provided in the body; and the motor connected to the battery and providing driving force to the at least one driving means or the brushless exciter system.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a perspective view illustrating a motor according to an embodiment of the present disclosure;

FIG. 2 is an exploded perspective view illustrating a motor and a brushless exciter system according to an embodiment of the present disclosure;

FIG. 3 is a cross-sectional view illustrating a motor according to an embodiment of the present disclosure;

FIG. 4 is a block diagram illustrating a motor and a brushless exciter system according to an embodiment of the present disclosure;

FIG. 5 is an equivalent circuit diagram illustrating a motor and a brushless exciter system according to an embodiment of the present disclosure;

FIG. 6 is a perspective view illustrating primary and secondary coils of a motor and a brushless exciter system according to an embodiment of the present disclosure;

FIG. 7 is a diagram illustrating a flow of currents of the secondary coil of FIG. 6;

FIG. 8 is a plan view illustrating an upper surface of the secondary coil of FIG. 6;

FIG. 9 is a back view illustrating a lower surface of the secondary coil of FIG. 6;

FIG. 10 is a perspective view illustrating a structure in which secondary coils of a multilayer structure of a motor and a brushless exciter system according to an embodiment of the present disclosure are disposed on a primary coil;

FIG. 11 is a partial perspective view illustrating a combined structure of primary and secondary coils of a motor and a brushless exciter system according to an embodiment of the present disclosure;

FIG. 12 is a perspective view illustrating a magnetic core accommodating primary and secondary coils of a motor and a brushless exciter system according to an embodiment of the present disclosure;

FIG. 13 is a perspective view illustrating a mobility device to which a motor and a brushless exciter system according to an embodiment of the present disclosure is applied; and

FIGS. 14a and 14b are perspective views illustrating a mobility device to which a motor and a brushless exciter system according to an embodiment of the present disclosure is applied.

### DETAILED DESCRIPTION

While the present disclosure may be modified in various manners and take on various alternative forms, specific embodiments thereof are illustrated in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It should be understood that, although the terms “first,” “second,” and the like may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms, such as “unit,” “part,” “portion,” and the like may be used to describe various components, but the components should not be limited by these terms. The above terms may refer to not only physically/visually distinct components, but also to functions or components of a portion even if the corresponding portion is not clearly divided.

The terms used herein to describe embodiments of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It should be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those having ordinary skill in the art to which the present disclosure pertains. Such terms as defined in generally used dictionaries should be construed to have the same meanings as those of the contexts of the related art, and they should not be construed to have ideally or excessively formal meanings, unless clearly defined in the application.

In this specification, a mobility device (i.e., mobility apparatus or vehicle) may move in a space related to the ground, underground, air, space, sea, and/or underwater, depending on the space in which the mobility device moves. Mobility devices on the ground or underground may be provided in the form of, for example, vehicles, robots, and the like, and mobility devices in the air or space, as aerial mobility devices, may be provided in the form of, for example, typical fixed-wing or rotary-wing aircraft, advanced aerial mobility devices (AAMs), which have been actively developed recently, unmanned aerial vehicles or drones, rockets, and units of transportation mounted on artificial satellites. A maritime or underwater mobility device may be, for example, a ship, a submarine, or the like. The mobility device is not limited to a specific space and may be a mobile body that may move through all of the aforementioned spaces, i.e., a mobile body that may move between multiple spaces, and may be, for example, an amphibious vehicle, a flying vehicle, and the like.

In the description below, the terms “anterior,” “posterior,” “lateral,” “front,” “rear,” “up/down,” “above,” “upper,” “top,” “below,” “lower,” “bottom,” “left/right,” and the like are defined based on a vehicle or a vehicle body. In addition, terms, such as “first,” “second” and the like may be used to describe various components, but these components should not be limited in order, size, location, or importance by terms, such as first and second. These terms are only used to distinguish one component from another. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus. In the present disclosure, each of phrases such as “A or B”, “at least one of A and B”, “at least one of A or B”, “A, B or C”, “at least one of A, B and C”, “at least one of A, B or C” and “at least one of A, B, or C, or a combination thereof” may include any one or all possible combinations of the items listed together in the corresponding one of the phrases.

Hereinafter, embodiments of the present disclosure are described in more detail with reference to the attached drawings.

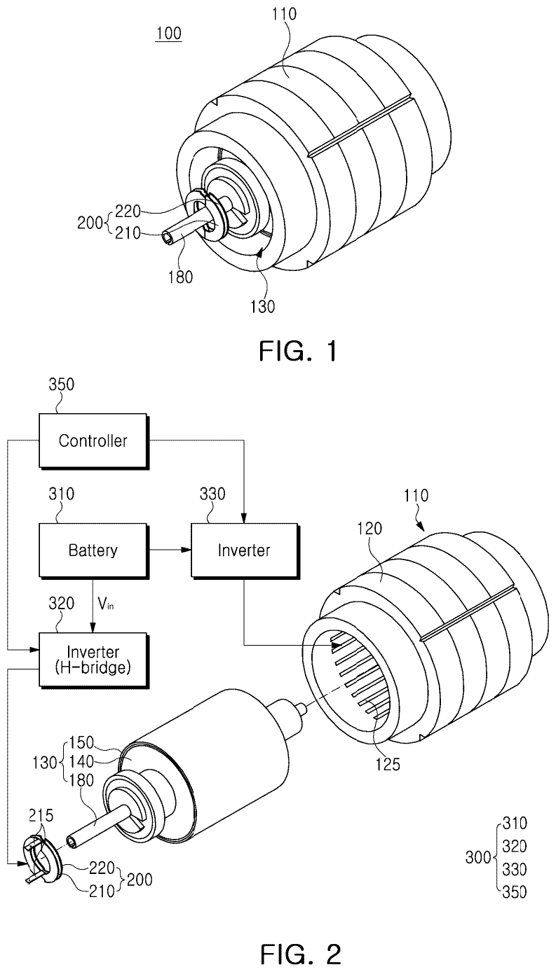

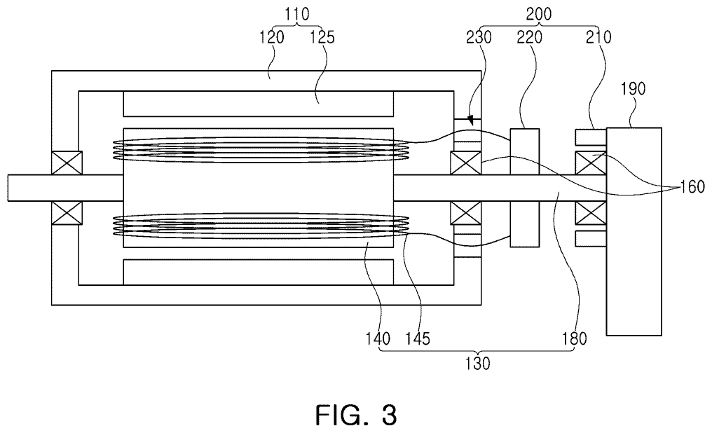

Referring to FIGS. 1-5, a motor 100 according to an embodiment of the present disclosure may include a stator 110, a rotor 130, a secondary coil 220, a rectifier 230, and a primary coil 210. A brushless exciter system according to an embodiment of the present disclosure may include a first inverter 320, a brushless exciter 200 having a primary coil 210 and a secondary coil 220, and may further include a second inverter 330.

The first inverter 320 may be configured to convert a direct current (DC) into an alternating current (AC) and output a first alternating current (AC). The second inverter 330 may be configured to convert a direct current (DC) into an alternating current (AC) and output a second alternating current (AC) to the motor 100. The motor 100 may be a wound field synchronous motor (WFSM), but an embodiment thereof is not limited thereto.

Each of the first and second inverters 320 and 330 may receive direct current power (Vin, Udc) from a battery 310, and a switching control signal from a controller 350. For example, each of the first and second inverters 320 and 330 may include a plurality of switching elements (TA+, TA−, TB+, TB−), and each of the plurality of switching elements (TA+, TA−, TB+, TB−) may switch (switch between an on state and an off state) based on a switching control signal of the controller 350. For example, each of the plurality of switching elements (TA+, TA−, TB+, TB−) may have a structure in which a power transistor, such as an Insulated Gate Bipolar Transistor (IGBT) and a diode are connected to each other (a capacitor may be further connected).

For example, a plurality of switching elements (TA+, TA−, TB+, TB−) may be combined in an H-bridge structure, and direct current power sources (Vᵢₙ, U_{dc}) may be input through four edges of the H-bridge structure, and a first alternating current (AC) may be output through a central portion (bridge) of the H-bridge structure. The H-bridge structure may be an efficient structure in a wireless power transmission method between the primary coil 210 and the secondary coil 220.

For example, the controller 350 may generate the switching control signal based on a pulse width modulation (PWM) method, and control switching timing of a plurality of switching elements (TA+, TA−, TB+, TB−) to control a pulse width of the PWM method. For example, the controller 350 may be implemented as at least a portion of a computing system (including a processor, memory, storage, input/output devices, and communication devices), or may be implemented as a microcontroller, an embedded system, a system on chip (SoC), or the like.

The stator 110 may output magnetic flux. For example, the stator 110 may include a stator body 120 having an internal space in which a rotor 130 is disposed, and may include a stator coil portion 125 arranged in the stator body 120 in a rotational direction of the rotor 130. The stator 110 may output magnetic flux based on a current flowing in the stator coil portion 125.

The second inverter 330 may output the second AC current to the stator coil portion 125. For example, the stator body 120 may have a plurality of terminals that are drawn out to electrically connect the internal stator coil portion 125 to the external second inverter 330. For example, the second inverter 330 may output a three-phase second AC current, and can output the three-phase second AC current to each of the plurality of stator coils of the stator coil portion 125. Each of the plurality of stator coils can output magnetic flux toward the rotor 130, and output magnetic flux at a time within a magnetic flux output timing range corresponding to a rotation angle of the rotor 130 in real time.

The rotor 130 may output magnetic flux to rotate by the magnetic flux of the stator 110. The first inverter 320 may form currents in a rotor coil portion 145 of the rotor 130 through the brushless exciter 200 based on a first alternating current (AC). Depending on the current in the rotor coil portion 145, the rotor 130 may output magnetic flux, and the magnetic flux of the rotor 130 and the magnetic flux of the stator 110 may electromagnetically interact. Force resulting from the interaction may be applied to the rotor 130, and depending on a rotating shaft 180 that can be included in the rotor 130, the force can act as rotational force rotating the rotor 130.

For example, a rotor body 140 of the rotor 130 may have a cylindrical or cylindrical shape, and the stator body 120 may have a cylindrical or cylindrical shape surrounding the rotor body 140. For example, the rotor body 140 of the rotor 130 may be fixedly installed on the rotating shaft 180, and the rotor body 140 may rotate around the rotating shaft 180 together with the rotating shaft 180 inside the stator body 120. FIGS. 1-3 illustrate a structure in which a rotor body 140 is disposed in an internal space of a stator body 120, but depending on the design, the structure may be replaced with a structure in which the rotor body 140 surrounds the stator 110.

Since the rotor 130 may rotate while receiving a current to output magnetic flux, it may require current transfer between a rotating conductive structure and a fixed conductive structure.

In general, a brush may be used to maintain a connection state between the rotating conductive structure and the fixed conductive structure. However, the brush may cause mechanical friction between the rotating conductive structure and the fixed conductive structure, cause a decrease in efficiency and/or a decrease in control characteristics due to the mechanical friction, or require a larger volume/weight (and/or periodic maintenance) of the motor considering mechanical friction.

A primary coil 210 of the brushless exciter 200 may be disposed to be magnetically coupled to a secondary coil 220, and may receive the first AC current from the first inverter 320. A secondary coil 220 of the brushless exciter 200 may be disposed to rotate by the rotation of the rotor 130, and may be magnetically coupled to the primary coil 210 and electrically connected to the rotor 130 of the motor 100. A rectifier 230 of the brushless exciter 200 may be electrically connected between the secondary coil 220 and the motor 100, and may be configured to rectify a current of the secondary coil 220 and output the rectified current to the rotor 130.

Accordingly, the brushless exciter 200 may transfer the current of the primary coil 210 to the secondary coil 220 based on the magnetic coupling between the primary coil 210 and the secondary coil 220. In this example, even if the secondary coil 220 rotates, the magnetic coupling between the primary coil 210 and the secondary coil 220 may be maintained. In other words, the brushless exciter 200 may transmit a current from the fixed conductive structure (a primary coil 210 and a structure connected thereto) to the rotating conductive structure (a secondary coil 220 and a structure connected thereto) without a brush. It can eliminate the disadvantages of brushes (e.g. mechanical friction, a decrease in efficiency, a decrease in control characteristics, additional volume/weight requirement, periodic maintenance requirement).

For example, the secondary coil 220 may be disposed to surround a rotating shaft 180 in a winding direction, and the primary coil 210 may be disposed to surround a rotating shaft 180 in the winding direction. Accordingly, the mutual inductance of the primary coil 210 and the secondary coil 220 may be increased, and the current transfer efficiency between the primary coil 210 and the secondary coil 220 may be increased. FIG. 1 illustrates a structure in which the primary coil 210 and the secondary coil 220 are disposed outside the stator body 120, but depending on the design, the primary coil 210 and the secondary coil 220 may be disposed within a receiving space of the stator body 120 (e.g., an edge space that is not substantially affected by the magnetic flux between the stator 110/rotor 130).

For example, the rotor 130 may further include a bearing 160 surrounding the rotating shaft 180, and the primary coil 210 may be disposed to surround at least a portion of the bearing 160 in a winding direction. The bearing 160 may maintain a position of the rotating shaft 180 while the rotating shaft 180 rotates, and may be configured (e.g., including ball bearings inside the bearing 160) so that the outer side of the bearing 160 does not rotate due to the rotation of the rotating shaft 180. Since the primary coil 210 is disposed on the outer side of at least a portion of the bearing 160, the primary coil 210 may be fixed without rotating by the rotation of the rotating shaft 180. For example, the primary coil 210 may include a primary terminal 215 that is wired to the outside of the motor 100 to receive a first alternating current (AC) from the outside of the motor 100.

For example, a portion of the bearing 160 may be surrounded by both ends of the stator body 120 (forming a hole through which the rotating shaft 180 passes), and the stator body 120 may be fixed without rotating by the stator body 180. A bearing support portion 190 may support at least a portion of the bearing 160 in an extension direction to prevent at least a portion of the bearing 160 from moving in the extension direction of the rotating shaft 180.

The stator body 120 may have an electrical connection path between the secondary coil 220 and the rotor 130. For example, the electrical connection path may be formed at one end of the stator body 120 facing the secondary coil 220 and may have a ring shape surrounding a portion of the bearing 160. For example, at least a portion of the rectifier 230 (e.g., anode/cathode portion diodes) may be disposed in the electrical connection path.

For example, the rotor 130 may include a rotor body 140 and/or a rotor coil portion 145, and the rotor coil portion 145 may include a superconducting coil. For example, when a magnetic body 150 of the rotor 130 is a superconducting wire, the rotor coil portion 145 may be defined as a superconducting coil. For example, for superconductivity of a superconducting coil, the motor and/or brushless exciter system may include a vacuum chamber (not shown).

For example, the magnetic body 150 may be a superconducting wire, a copper or aluminum wire, or the like. When the magnetic body 150 is a superconducting wire, the superconducting wire may use a MHoS (Multi-HTS layers on one Substrate) structure or a Stacked HTS (high-temperature superconductivity) wire structure in which superconducting wires are stacked. According to the design, an outer surface of the magnetic body 150 may include a cylindrical rotor sleeve fixedly connected to the magnetic body 150 or the rotor body 140 to prevent the magnetic body 150 from being detached. The rotor sleeve may be provided with a nonmagnetic material (STS (Steel Type Stainless), CFRP (Carbon Fiber Reinforced Plastic), or the like).

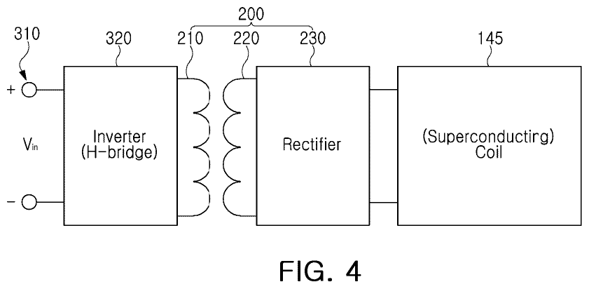

Referring to FIGS. 4-6, the primary coil 210 and/or the primary terminal (215 in FIG. 2) may be comprised of a series equivalent resistance (R₁), a series equivalent inductance (L₁ₐ), and a mutual inductance (L_{M}). The winding directions of the primary coil 210 and the secondary coil 220 may be the same or opposite to each other. A transformation ratio of the primary coil 210 and the secondary coil 220 may be a value obtained by dividing the number of turns (N₁) of the primary coil 210 by the number of turns (N₂) of the secondary coil 220.

For example, the number of turns (N₂) of the secondary coil 220 may be less than the number of turns (N₁) of the primary coil 210, a voltage of the secondary coil 220 may be lower than a voltage of the primary coil 210, and a current (i₂) of the secondary coil 220 may be greater than a current (i₁) of the primary coil 210. For example, the number of turns (N₁) may be tens or hundreds of turns, and the number of turns (N₂) may be 1 turn.

An energy loss due to a flow of current may increase as current increases. Since the current (i₂) may be larger than the current (i₁), a line width of the secondary coil 220 may be wider than a line width of the primary coil 210 to reduce the energy loss due to the current (i₂). Accordingly, the overall energy efficiency of the brushless exciter 200 may be increased. For example, the primary coil 210 may be wound in a small number of layers (e.g., one layer) with a narrow line width and long windings, and the secondary coil 220 may be wound once per layer with a wide line width.

The secondary coil 220 may include an anode terminal P, a cathode terminal N, and a neutral terminal M. The rectifier 230 includes a rectifier anode portion 230a electrically connected between one end of the rotor coil portion 145 and the anode terminal P, and a rectifier cathode portion 230b electrically connected between one end of the rotor coil portion 145 and the cathode terminal N, and the neutral terminal M may be electrically connected to the other end of the rotor coil portion 145.

Accordingly, since a current (i_{f}) of the rotor coil portion 145 may be unidirectional, rectification between the other end of the rotor coil portion 145 and the neutral terminal M may not be required. Therefore, the rectifier 230 may be simplified overall (e.g., the total number of diodes may be reduced by half).

By rectification of the rectifier 230, the current (i₂) of the secondary coil 220 may flow through the rectifier anode portion 230a for half of one cycle, and through the rectifier cathode portion 230b for the remainder of one cycle. The current (i₂) may be affected by series equivalent resistance (R_{2.1}, R_{2.2}) and series equivalent inductance (L₂ₐ) of the rectifier 230, and the current (i₂) may be affected by the series equivalent resistance (R_{f}) and series equivalent inductance (L_{f}) of the rotor coil portion 145.

For example, the rectifier anode portion 230a may include an anode portion diode (DA), and the rectifier cathode portion 230b may include a cathode portion diode (DB), and each of the anode portion diode (DA) and the cathode portion diode (DB) may rectify the current (i₂). Since a diode may not be connected between the other end of the rotor coil portion 145 and the neutral terminal M, the rectifier 230 may be configured to rectify the current of the secondary coil 220 through a single anode portion diode (DA) and a single cathode portion diode (DB).

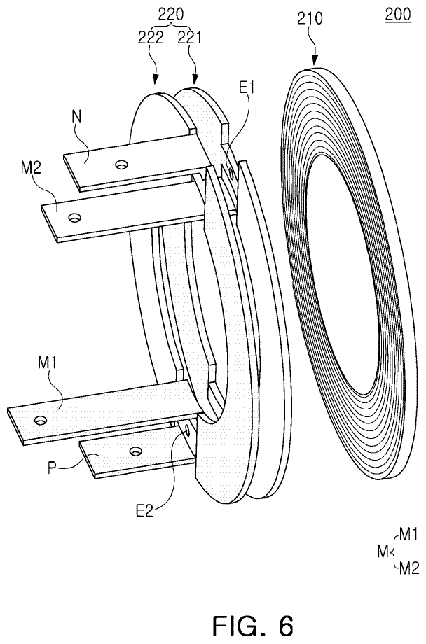

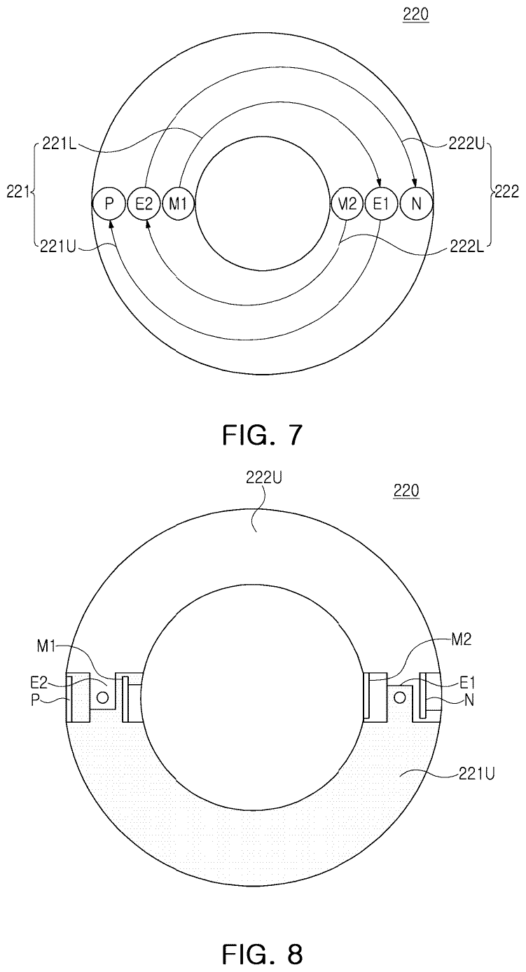

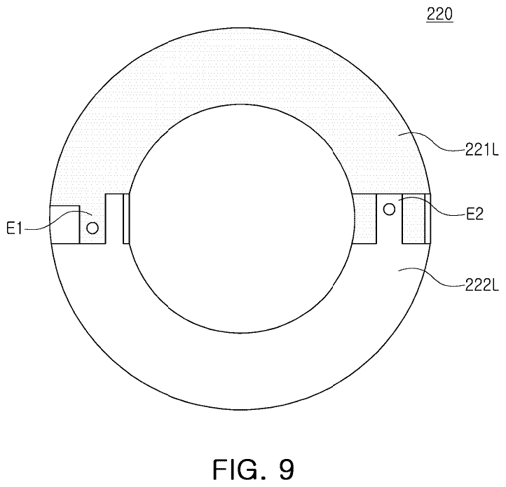

Referring to FIGS. 6-9, the neutral terminal M may include an anode portion neutral terminal M1 and a cathode portion neutral terminal M2 electrically connected to each other. The secondary coil 220 may include a secondary anode portion 221 wound between the anode terminal P and the anode portion neutral terminal M1, and a secondary cathode portion 222 wound between the cathode terminal N and the cathode portion neutral terminal M2. FIGS. 6-11 illustrate a secondary anode portion 221 with hatched dots and a secondary cathode portion 222 without hatches.

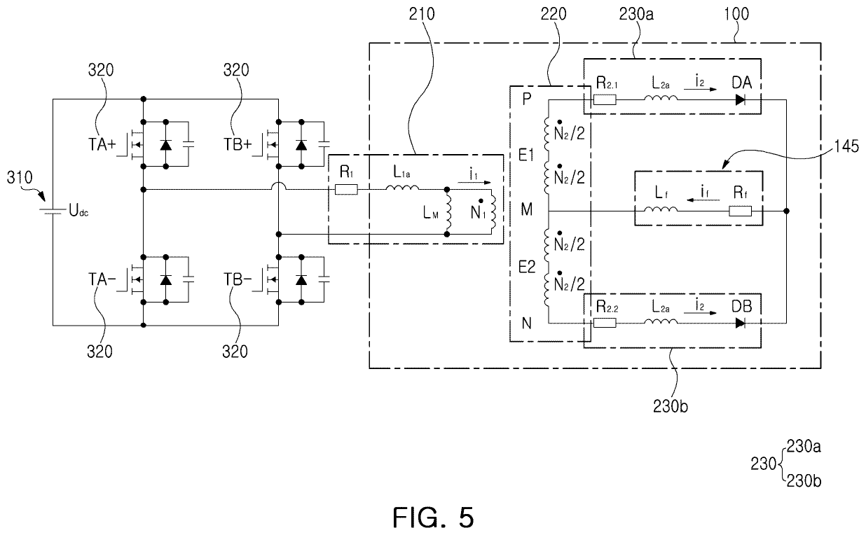

A voltage formed between the anode terminal P and the cathode terminal N may be twice a voltage formed between the anode terminal P and the neutral terminal M, and may be twice a voltage formed between the cathode terminal N and the neutral terminal M. The current (i₂ in FIG. 5) of the secondary coil 220 may flow through the secondary anode portion 221 for half of one cycle, and may flow through the secondary cathode portion 222 for the remainder of one cycle. Accordingly, the number of turns (N₂ in FIG. 5) of the secondary coil 220 may be an average value (e.g., 1 turn) of the number of turns (e.g., 1 turn) of the secondary anode portion 221 and the number of turns (e.g., 1 turn) of the secondary cathode portion 222.

The secondary anode portion 221 may include a secondary anode upper layer 221U, a secondary anode lower layer 221L, and a secondary anode lifting portion E1 connected between the secondary anode upper layer 221U and the secondary anode lower layer 221L. The secondary cathode portion 222 may include a secondary cathode upper layer 222U, a secondary cathode lower layer 222L, and a secondary cathode lifting portion E2 connected between the secondary cathode upper layer 222U and the secondary cathode lower layer 222L. The secondary anode upper layer 221U and the secondary cathode lower layer 222L may overlap each other in a direction perpendicular to a winding direction, and the secondary cathode upper layer 222U and the secondary anode lower layer 221L may overlap each other in a direction perpendicular to the winding direction.

The structure may be defined as a transpose structure, and may reduce a difference in shapes (e.g., difference in pores) between the secondary anode portion 221 and the secondary cathode portion 222, increase symmetry between the secondary anode portion 221 and the secondary cathode portion 222, and may be advantageous in widening an overall line width of the secondary anode portion 221 and the secondary cathode portion 222. Therefore, the overall energy efficiency of the secondary coil 220 may be further improved, and a difference between half of one cycle of the current of the secondary coil 220 and the remainder thereof may be reduced (and/or the motor control accuracy/efficiency may be improved).

For example, the anode portion neutral terminal M1 and the cathode portion neutral terminal M2 and the anode terminal P and the cathode terminal N may protrude in one direction. The secondary anode lifting portion E1 may have a narrower line width than the remaining portion of the secondary anode portion 221, and may be disposed between the cathode portion neutral terminal M2 and the cathode terminal N. The secondary cathode lifting portion E2 may have a narrower line width than the remainder of the secondary cathode portion 222, and may be disposed between the anode portion neutral terminal M1 and the anode terminal P.

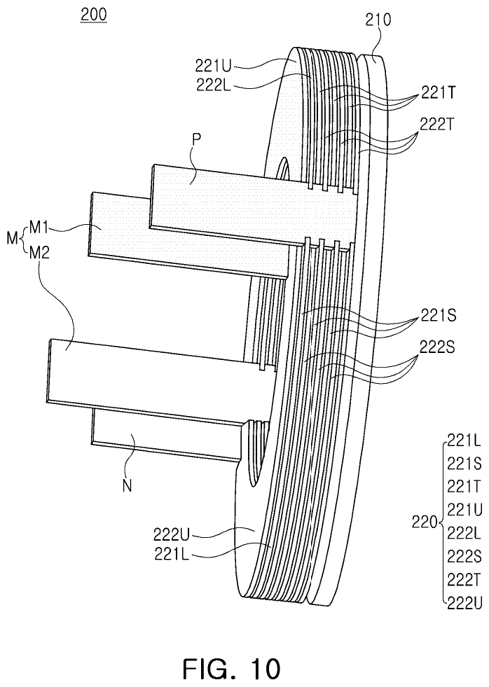

Referring to FIG. 10, the secondary anode upper layer 221U may include a plurality of secondary anode upper layers 221T, the secondary anode lower layer 221L may include a plurality of secondary anode lower layers 221S, the secondary cathode upper layer 222U may include a plurality of secondary cathode upper layers 222S, the secondary cathode lower layer 222L may include a plurality of secondary cathode lower layers 222T, and the plurality of secondary anode upper layers 221T and the plurality of secondary cathode lower layers 222T may be alternately stacked, and the plurality of secondary cathode upper layers 222S and the plurality of secondary anode lower layers 221S may be alternately stacked.

This structure may be defined as a multi-layer transpose structure. For example, the plurality of secondary anode lower layers 221S and the plurality of secondary anode upper layers 221T may be directly connected to an anode terminal P and an anode portion neutral terminal M1, and the plurality of secondary cathode upper layers 222S and the plurality of secondary cathode lower layers 222T may be directly connected to a cathode terminal N and a cathode portion neutral terminal M2. This structure may be a structure in which the plurality of secondary coils 220 of FIGS. 6-9 are connected in parallel with each other, and may have the effect of widening a line width of the secondary coil 220, thereby further increasing the overall energy efficiency. Even if the multilayer transformer structure further increases the number of layers of the secondary coil 220, the multilayer transformer structure can maintain high identity/symmetry between the secondary anode portion 221 and the secondary cathode portion 222.

FIG. 10 illustrates a structure in which a plurality of transpose structures are connected in parallel with each other, but depending on the design, the plurality of transpose structures may be connected in series with each other. Accordingly, the number of turns (N₂ in FIG. 5) of the secondary coil 220 may be increased.

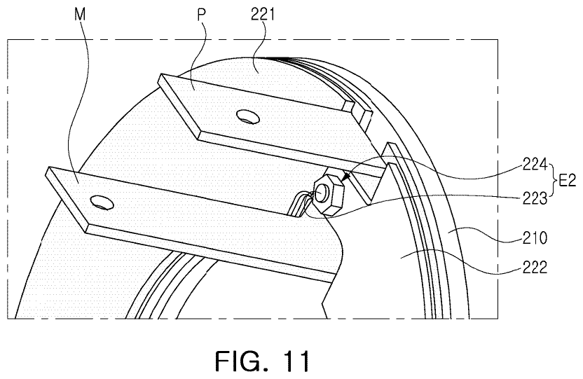

Referring to FIGS. 6 and 11, each of the secondary cathode lifting portion E1 and the secondary anode lifting portion E2 may include a connecting portion 223 and a fixed portion 224. For example, the connecting portion 223 and the fixed portion 224 may be implemented as a bolt and a nut, respectively, but an embodiment thereof is not limited thereto. For example, the connecting portion 223 and the fixed portion 224 may be implemented as a fusion structure such as solder. The connecting portion 223 may connect the secondary anode upper layer 221U and the secondary anode lower layer 221L to each other in the secondary anode lifting portion E1, and may connect the secondary anode upper layer 221U and the secondary anode lower layer 221L to each other in the secondary cathode lifting portion E2. The fixed portion 224 may be used to bring the secondary anode upper layer 221U and the secondary anode lower layer 221L into close contact with each other in the secondary anode lifting portion E1, and may be used to bring the secondary anode upper layer 221U and the secondary anode lower layer 221L into close contact with each other in the secondary cathode lifting portion E2.

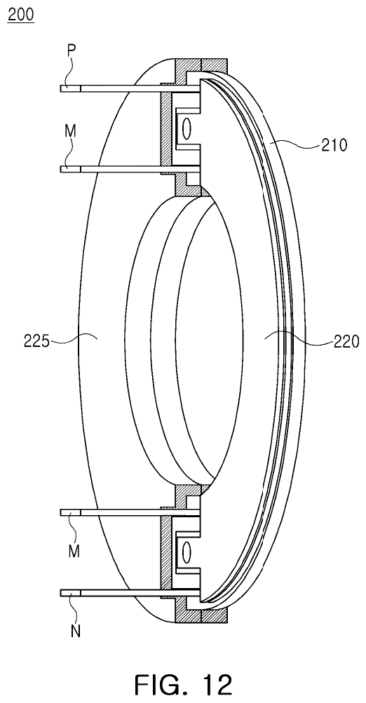

Referring to FIG. 12, a motor and a brushless exciter system according to an embodiment of the present disclosure may further include a tube-shaped magnetic core 225 including a ferromagnetic material (e.g., ferrite), and a primary coil 210 and a secondary coil 220 may be disposed within the magnetic core 225. Accordingly, the mutual inductance of the primary coil 210 and the secondary coil 220 may increase, and the current transfer efficiency between the primary coil 210 and the secondary coil 220 may increase. FIG. 12 illustrates only half of a tubular shape of the magnetic core 225, but the magnetic core 225 may further include the remaining half of the tubular shape.

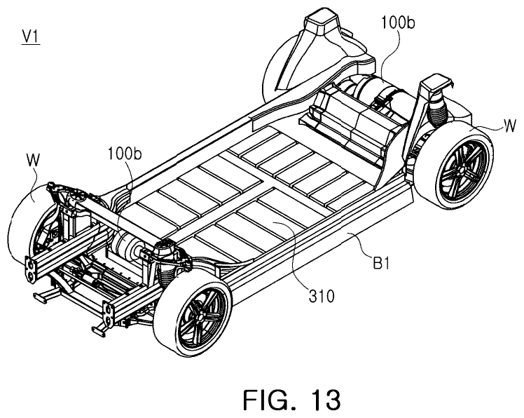

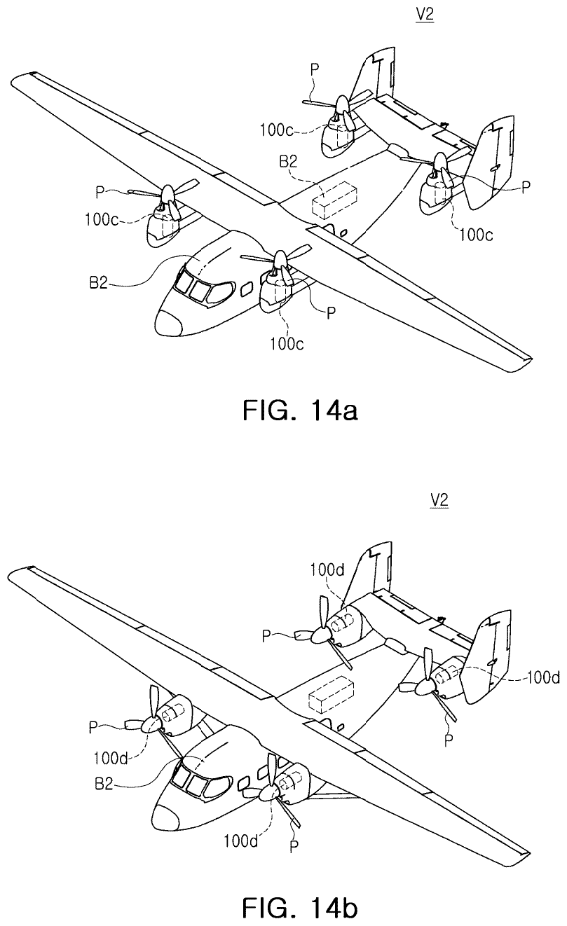

Referring to FIGS. 13-14b, the mobility device (V1 and V2) according to an embodiment of the present disclosure may include at least bodies (B1, B2), driving means (W, P) provided on the bodies (B1, B2), motors (100b, 100c, 100d) of the present embodiment linked to the driving means (W, P), and batteries 310 providing power to the motor. The motors (100b, 100c, 100d) installed in the mobility devices (V1 and V2) of the present embodiment may be the motors 100 and/or brushless exciter systems described with reference to FIGS. 1-12. The motor 100 and/or brushless exciter system described with reference to FIGS. 1-12 may be installed, and thus, a detailed description of a structure thereof has been omitted.

Referring to FIG. 13, the mobility device V1 in an embodiment may be a vehicle that may move on the ground. The vehicle V1, which is a mobility device, may include at least a body B1, a wheel W as a driving means provided in the body B1, a motor 100b linked to the driving means W, and a battery 310 providing driving force to the motor.

In addition, referring to FIGS. 14a and 14b, the mobility device V2 in an embodiment may be an aerial mobility device that moves in the air. The aerial mobility device V2 of an embodiment may include at least a fuselage B2 as a body, a propulsion body (a propeller P) as a driving means provided in the fuselage B2, a motor 100c 100d linked to the propulsion body P, and a battery providing driving force to the motor.

FIG. 14a illustrates a position of the propeller P when the aerial mobility device V2 takes off or lands or hovers for turning at a specific point, and FIG. 14b illustrates a position of the propeller P when the aerial mobility device V2 moves in position, i.e., drives or flies. In other words, the aerial mobility device V2 may have a structure in which a direction of the propeller P, which is a propulsion body of the aerial mobility device V2, is tilted, and accordingly, the motor 100d driving the propeller P may also be tilted.

In the case of a hovering mode illustrated in FIG. 14a, a main wing and/or tail wing tilting propeller P may be pivoted to be substantially perpendicular to the fuselage B2, and in the case of a cruise or flying mode illustrated in FIG. 14b, the main wing and/or tail wing tilting propulsion body P may be pivoted to be substantially parallel to the fuselage B2. The tilting of the main wing and/or tail wing tilting propulsion body P may be synchronized depending on a flight mode, and tilting of each propeller may be adjusted to be different depending on posture control and flight conditions in the same flight mode.

Although specific illustrations thereof are omitted, a mobility device may be a device that moves through spaces related to the ground, underground, air, space, sea, and/or underwater, depending on the space in which the mobility device moves. Mobility devices on the ground or underground may be provided in the form of, for example, vehicles, robots, and the like, and mobility devices in the air or space, as aerial mobility devices, may be provided in the form of, for example, typical fixed-wing or rotary-wing aircraft, advanced aerial mobility devices (AAMs), which have been actively developed recently, unmanned aerial vehicles or drones, rockets, and units of transportation mounted on artificial satellites. A maritime or underwater mobility device may be, for example, a ship, a submarine, or the like. The mobility device is not limited to a specific space and may be a mobile body that may move through all of the aforementioned spaces, i.e., a mobile body that may move between multiple spaces, and may be, for example, an amphibious vehicle, a flying vehicle, and the like.

As set forth above, a motor, a brushless exciter system, and a mobility device according to an embodiment of the present disclosure may eliminate disadvantages of a brush (e.g., mechanical friction, reduced efficiency, reduced control characteristics, additional volume/weight requirements, and periodic maintenance requirements) while providing an excitation structure.

For example, the motor, the brushless exciter system, and the mobility device according to an embodiment of the present disclosure may have an overall simplified structure for rectification (e.g., reducing the total number of diodes by half), and may be advantageous in increasing energy efficiency for brushless excitation.

While embodiments have been illustrated and described above, it should be apparent to those having ordinary skill in the art that modifications and variations could be made without departing from the scope of the present disclosure as defined by the appended claims.

What is claimed is:

1. A motor, comprising:
a stator configured to output magnetic flux;
a rotor configured to output magnetic flux to be rotated by the magnetic flux of the stator;
a secondary coil rotatable by the rotation of the rotor;
a rectifier configured to rectify a current of the secondary coil and output the rectified current to the rotor; and
a primary coil magnetically couplable to the secondary coil.

2. The motor of claim 1, wherein
the rotor includes a rotating shaft,
the secondary coil surrounds the rotating shaft in a winding direction of the secondary coil, and
the primary coil surrounds the rotating shaft in a winding direction of the primary coil.

3. The motor of claim 2, wherein the rotor further includes a bearing surrounding the rotating shaft, and
wherein the primary coil surrounds at least a portion of the bearing in the winding direction of the primary coil.

4. The motor of claim 1, wherein the primary coil includes a primary terminal wired to an outside of the motor to receive an alternating current from the outside of the motor.

5. The motor of claim 1, wherein the stator includes:
a stator body having an internal space in which the rotor is disposed; and
a stator coil portion arranged in the stator body in a rotational direction of the rotor,
wherein the stator body has an electrical connection path between the secondary coil and the rotor.

6. The motor of claim 1, wherein a number of turns of the secondary coil is less than a number of turns of the primary coil, and
wherein a line width of the secondary coil is greater than a line width of the primary coil.

7. The motor of claim 1, wherein the rotor includes a rotor coil portion, and
the rotor coil portion includes a superconducting coil.

8. The motor of claim 1, wherein
the rotor includes a rotor coil portion,
the secondary coil includes an anode terminal, a cathode terminal, and a neutral terminal,
the rectifier includes a rectifier anode portion electrically connected between one end of the rotor coil portion and the anode terminal, and a rectifier cathode portion electrically connected between one end of the rotor coil portion and the cathode terminal, and
the neutral terminal is electrically connected to another end of the rotor coil portion.

9. The motor of claim 8, wherein
the rectifier anode portion includes an anode portion diode, and
the rectifier cathode portion includes a cathode portion diode.

10. The motor of claim 8, wherein the neutral terminal includes an anode portion neutral terminal and a cathode portion neutral terminal, and
the secondary coil includes a secondary anode portion wound between the anode terminal and the anode portion neutral terminal, and a secondary cathode portion wound between the cathode terminal and the cathode portion neutral terminal.

11. The motor of claim 10, wherein
the secondary anode portion includes at least one secondary anode upper layer, at least one secondary anode lower layer, and a secondary anode lifting portion connected between the at least one secondary anode upper layer and the at least one secondary anode lower layer,
the secondary cathode portion includes at least one secondary cathode upper layer, at least one secondary cathode lower layer, and a secondary cathode lifting portion connected between the at least one secondary cathode upper layer and the at least one secondary cathode lower layer,
the at least one secondary anode upper layer and the at least one secondary cathode lower layer overlap each other in a direction perpendicular to a winding direction of the secondary coil, and
the at least one secondary cathode upper layer and the at least one secondary anode lower layer overlap each other in a direction perpendicular to the winding direction of the secondary coil.

12. The motor of claim 11, wherein
the at least one secondary anode upper layer includes a plurality of secondary anode upper layers,
the at least one secondary anode lower layer includes a plurality of secondary anode lower layers,
the at least one secondary cathode upper layer includes a plurality of secondary cathode upper layers,
the at least one secondary cathode lower layer includes a plurality of secondary cathode lower layers,
respective secondary anode upper layers of the plurality of secondary anode upper layers and respective secondary cathode lower layers of the plurality of secondary cathode lower layers are alternately stacked, and
respective secondary cathode upper layers of the plurality of secondary cathode upper layers and respective secondary anode lower layers of the plurality of secondary anode lower layers are alternately stacked.

13. The motor of claim 1, further comprising a tube-shaped magnetic core including a ferromagnetic material, and
wherein the primary coil and the secondary coil are disposed within the tube-shaped magnetic core.

14. A brushless exciter system, comprising:
a first inverter configured to convert a direct current (DC) into an alternating current (AC) and output a first alternating current (AC);
a primary coil configured to receive the first alternating current (AC) from the first inverter; and
a secondary coil magnetically coupled to the primary coil and electrically connected to a rotor of a motor.

15. The brushless exciter system of claim 14, further comprising a second inverter configured to convert a direct current (DC) into an alternating current (AC) and output a second alternating current (AC) to a stator of the motor,
wherein the first inverter includes a plurality of switching elements combined in an H-bridge structure.

16. The brushless exciter system of claim 14, further comprising a rectifier electrically connected between the secondary coil and the motor,
wherein the rectifier is configured to rectify a current of the secondary coil through a single anode portion diode and a single cathode portion diode.

17. The brushless exciter system of claim 14, wherein
a number of turns of the secondary coil is less than a number of turns of the primary coil,
a line width of the secondary coil is greater than a line width of the primary coil, and
the motor includes a superconducting coil.

18. The brushless exciter system of claim 14, wherein the secondary coil includes an anode terminal, a cathode terminal, and a neutral terminal,
the neutral terminal includes an anode portion neutral terminal and a cathode portion neutral terminal,
the secondary coil includes a secondary anode portion wound between the anode terminal and the anode portion neutral terminal, and a secondary cathode portion wound between the cathode terminal and the cathode portion neutral terminal,
the secondary anode portion includes at least one secondary anode upper layer, at least one secondary anode lower layer, and a secondary anode lifting portion connected between the at least one secondary anode upper layer and the at least one secondary anode lower layer,
the secondary cathode portion includes at least one secondary cathode upper layer, at least one secondary cathode lower layer, and a secondary cathode lifting portion connected between the at least one secondary cathode upper layer and the at least one secondary cathode lower layer,
the at least one secondary anode upper layer and the at least one secondary cathode lower layer overlap each other in a direction perpendicular to a winding direction of the secondary coil, and
the at least one secondary cathode upper layer and the at least one secondary anode lower layer overlap each other in a direction perpendicular to the winding direction of the secondary coil.

19. The brushless exciter system of claim 14, wherein
the motor includes a rotating shaft,
the secondary coil surrounds the rotating shaft in a winding direction of the secondary coil, and
the primary coil surrounds the rotating shaft in a winding direction of the primary coil.

20. A mobility device, comprising:
a body;
at least one of a wheel or a propeller provided in the body;
a battery provided in the body; and
a motor connected to the battery and configured to provide driving force to the at least one of the wheel or the propeller,
wherein the motor comprises
a stator configured to output magnetic flux,
a rotor configured to output magnetic flux to be rotated by the magnetic flux of the stator,
a secondary coil disposed to be rotated by the rotation of the rotor,
a rectifier configured to rectify a current of the secondary coil and output the rectified current to the rotor, and
a primary coil disposed to be magnetically coupled to the secondary coil.
